(19) United States
(12) Patent Application Publication
(10) Pub. No.: US 2009/0079361 A1
(43) Pub. Date: Mar. 26, 2009

(54) METHOD AND DEVICE FOR DRIVING A DISCHARGE LAMP

(75) Inventors: Christianus Josephus Roozekrans, Roosendaal (NL); Leendert Huibert Goud, Roosendaal (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/280,570

(22) PCT Filed: Feb. 2, 2007
(86) PCT No.: PCT/IB07/50351

§ 371 Date: Aug. 25, 2008

(30) Foreign Application Priority Data
Feb. 28, 2006 (EP) 06110487.3

(51) Int. Cl. H05B 41/36

(52) U.S. Cl. 315/291

(57) ABSTRACT

A method for driving a discharge lamp (1) having lamp electrodes (2, 3), at least one of said electrodes (2) being implemented as a filament having two electrode terminals (2a, 2b), comprises the following steps: during a first time interval (t1-t2), generating a discharge lamp current (I L) in said discharge lamp (1); during a second time interval (t2-t3), interrupting the discharge lamp current (I L); during both intervals (t1-t3), passing an electrode heating current (I C) through said one electrode (2); wherein, during said first time interval (t1-t2), the discharge lamp current magnitude (I L1) is less than 90% of the nominal current magnitude (I NOM); and wherein the electrode heating current (I C) is set such that the hot resistance R H of said one electrode (2) is within 4.3 to 4.7 times the cold resistance R C; wherein during the second time interval, the electrode heating current is larger than during the first time interval.

### FIELD OF THE INVENTION

The present invention relates in general to a method and device for driving a discharge lamp, specifically a fluorescent lamp.

### BACKGROUND OF THE INVENTION

A fluorescent lamp comprises, in general, a transparent vessel, typically glass, usually of a tubular shape, having two electrodes disposed at opposite ends of such tube. The tube contains a specific gas atmosphere, typically comprising more than 50% Argon. In operation, an electrical power source is connected to the electrodes, such that a discharge is caused in said atmosphere. During discharge operation of the lamp, the voltage over said electrodes has a typical value, indicated as lamp voltage, and the current through the lamp has a typical value, indicated as lamp current. Although the lamp current can typically be controlled by a driving power source, or driver, a lamp has typical nominal operating voltage and operating current values which depend on lamp type. The lamp is capable of being continuously operated at nominal operational parameters, i.e. nominal voltage and nominal current, and under those nominal operational conditions the lamp generates a typical light intensity according to design specifications.

There are situations where it is desirable that the fluorescent lamp is operated in a switched mode, in which the lamp is alternatively switched ON and OFF at a certain switching frequency.

For instance, it may be desired that the light output is reduced, i.e. that the lamp is dimmed. When the lamp is operated in a switched mode, the lamp generates light only during the ON-periods and generates no light during the OFF-periods. The switching frequency is typically selected to be 100 Hz or more, in order to prevent undesirable flicker phenomena. Then, the human eye only observes an average light intensity which depends on the duty cycle, i.e. the ratio of the ON-periods with respect to the total switching period. In another example, a fluorescent lamp may be arranged in an array of multiple fluorescent lamps, and it may be desirable to alternatively switch the lamps on and off. An example of such application is a scanning backlight unit such as used for instance in an LCD television.

For adequate lamp operation, the cathode should have a certain operational temperature in order to be able to emit electrons which carry the lamp current across the lamp atmosphere to the anode. If the cathode is too cold, it becomes difficult to re-ignite the lamp current for the next ON-period. Re-ignition may then require the use of high-voltage ignition pulses.

On the other hand, if the cathode is too hot, there are consequences of heating the glass tube, heating the surroundings, and increasing the mercury pressure inside the tube.

Further, the lamp electrode is provided with an emitter material, typically barium. During use, this emitter material is consumed, and this consumption depends strongly on the electrode temperature. The amount of emitter material is finite. Once the emitter material has been consumed completely, the lamp has reached the end of its lifetime. Thus, a high electrode temperature causes large consumption of emitter material which reduces the lifetime of the lamp.

Thus, it is known that the operational temperature of the cathode should be within certain predefined margins.

The cathode is heated by the lamp discharge current. When the lamp is operated in a switched mode to achieve dimming, the lamp discharge current can only heat the cathode during the ON periods of the lamp. When the duty cycle of the lamp current is reduced, the heat input to the cathode from the lamp discharge current is likewise reduced, resulting in a cooler electrode.

In order to prevent this problem, it is known to provide additional heat to the cathode by passing an electric current through the cathode. In case of AC operation, both electrodes can act as cathode, so both electrodes are provided by electric heating means.

The basic operation of such lamp system may be explained with reference to the schematic illustration of FIG. 1. An elongate lamp 1 has opposite electrodes 2 and 3 connected to a first voltage source 4, providing a lamp voltage V_{L}; this voltage source will also be indicated as lamp power source. For the present explanation, it is assumed that the lamp power source 4 is a DC source, having a negative output terminal 4a and a positive output terminal 4b. Lamp electrode 2 connected to the negative output terminal 4a is the cathode of the lamp; the opposite electrode 3 is the anode. The cathode 2 is implemented as a spiral filament having two terminals 2a and 2b. The first cathode terminal 2a is connected to the negative power source terminal 4a. A second voltage source 5 has its output terminals connected to the electrode terminals 2a and 2b; this second voltage source will also be indicated as electrode power source. Although the polarity of the second power source 5 is not essential, the second power source 5 will typically have its negative output terminal connected to the first electrode terminal 2a and will typically have its positive output terminal connected to the second electrode terminal 2b.

It is noted that it may be that the lamp 1 has a symmetrical design; in that case, the anode will be implemented as a spiral filament as well.

A first controllable switch S1 is arranged in series with the lamp 1 and lamp power source 4. Further, a current limiting device C_{L} is arranged in series with the lamp 1 and lamp power source 4. A second controllable switch S2 is arranged in series with the lamp filament 2 and the electrode power source 5. The switches S1 and S2 are controlled by a controller 10. The controller 10 is designed to control the first switch S1 to alternatively close and open. FIG. 2 schematically illustrates the resulting lamp current I_{L}. On time t₁, the first switch S1 is closed and the lamp current I_{L} flows with a nominal current value I_{NOM}. On time t₂, the first switch S1 is opened, so that the lamp current is interrupted, illustrated as the lamp current I_{L} having a value 0. On time t₃, the first switch S1 is closed again, and the above is repeated. The time period from first time t₁ to third time t₃ is indicated as current period T. The duration from first time t₁ to second time t₂, during which the lamp current is flowing, is indicated as ON-time t_{ON}. A duty cycle Δ is defined as Δ=t_{ON}/T.

In order to provide heating of the cathode 2, a heating current is applied to the cathode 2 by closing the second switch S2.

In such cases where the lamp electrode is electrically heated, there is the problem of suitably setting the magnitude of the electrode heating current. This is already a problem when the lamp is operated in dimmed mode in order to achieve dimming, but this problem increases if the duty cycle of the lamp is varied in order to achieve variable dimming.

The electrode heating current directly influences the temperature of the electrode. Thus, if the electrode current is too low, the electrode temperature may be inadequate for ignition. On the other hand, if the electrode current is too high, the electrode may be too hot. Further, higher electrode currents result in higher electrical losses (I²R).

Further, the amount of emitter material per unit length of electrode has a certain maximum. In order to increase lifetime of the lamp, it is known to increase the electrode length. However, when the length of the electrode spiral is increased, also the resistance of the electrode increases, which in turn increases the electrical losses.

If an optimum electrode current magnitude is used, so that the emitter consumption is reduced, the total amount of emitter material in the electrode can be reduced while maintaining a long lifetime, meaning that the length of the electrode can be reduced, resulting in a reduced resistance, hence reduced electrical losses.

It is noted that Japanese patent application 1987-324854, published 28-6-1989 with publication number 1989-163998, discloses a driving circuit for an electric discharge lamp having electrode heating current, wherein the electrode heating power is switched on and off at a constant duty cycle, and wherein the lamp power is switched on and off at the same frequency. The lamp power is switched on only during the OFF period of the electrode heating power. The resulting lamp heating current I_{C} for such case is also shown in FIG. 2. The duty cycle of the lamp power is varied in order to dim the lamp. Thus, there is no electrode heating power applied when the lamp power is switched on. Further, there is a time period during which neither lamp power nor electrode heating power is applied. Although it is advantageous that electrode heating power is applied at least immediately before application of the lamp power, it has been found that this method of operation does not yield optimal conditions.

### SUMMARY OF THE INVENTION

According to an important aspect of the invention, a heating current is passed through the cathode during the OFF period of the lamp current as well as during the ON period of the lamp current. According to a further important aspect of the invention, the heating current during the OFF period of the lamp current is larger than heating current during the ON period of the lamp current; preferably, the heating current during the OFF period of the lamp current is equal to the summation of the lamp current and the heating current during the ON period. According to a further important aspect of the invention, the lamp current during the ON period is less than 90% of the nominal current, and the duty cycle is less than 70%.

It has been found that, with such settings, the temperature distribution in the electrode is homogenous, and the cathode drop is relatively low, so that, in all dim conditions (i.e. all power settings) a very long lifetime of the lamp can be achieved. Or, it is possible to reduce the size of the electrode and thus reducing the electrical losses while maintaining the lifetime.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 is a block diagram schematically illustrating the basic design of a lamp driver circuit in accordance with prior art;

FIG. 2 is a timing diagram schematically illustrating the timing of some currents in the lamp operating circuit of FIG. 1;

FIG. 3 is a block diagram schematically illustrating a possible embodiment of a lamp driver circuit according to the present invention;

FIG. 4 is a timing diagram schematically illustrating the timing of some signals in the driver circuit of FIG. 3;

FIG. 5 is a block diagram schematically illustrating another possible embodiment of a lamp driver circuit according to the present invention;

FIG. 6 is a block diagram schematically illustrating a lamp driver circuit for driving a plurality of lamps;

FIG. 7 is a timing diagram schematically illustrating the timing of some signals in the driver circuit of FIG. 6.

### DETAILED DESCRIPTION OF THE INVENTION

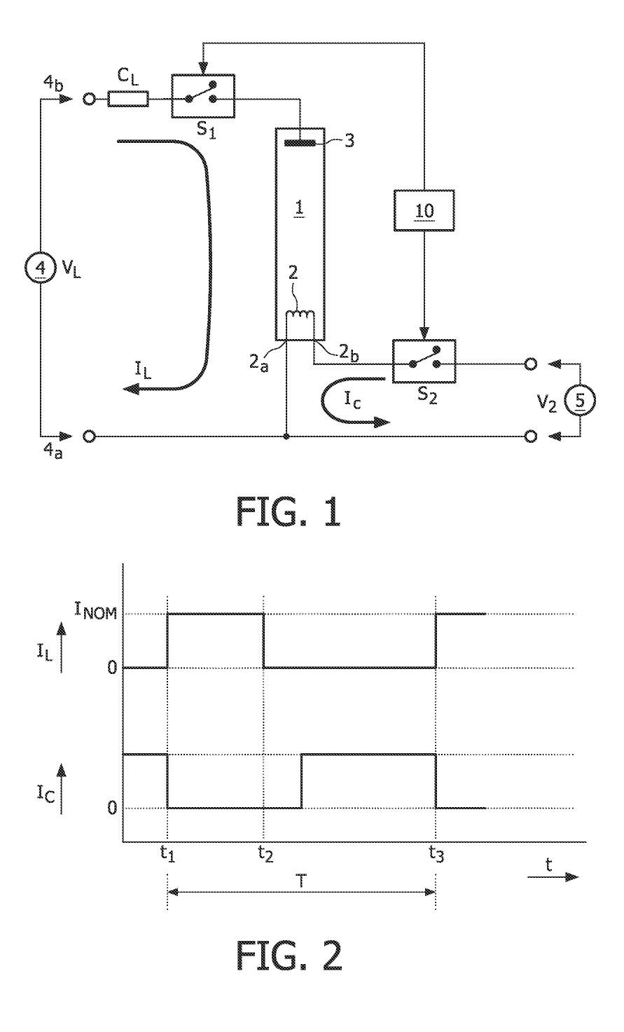

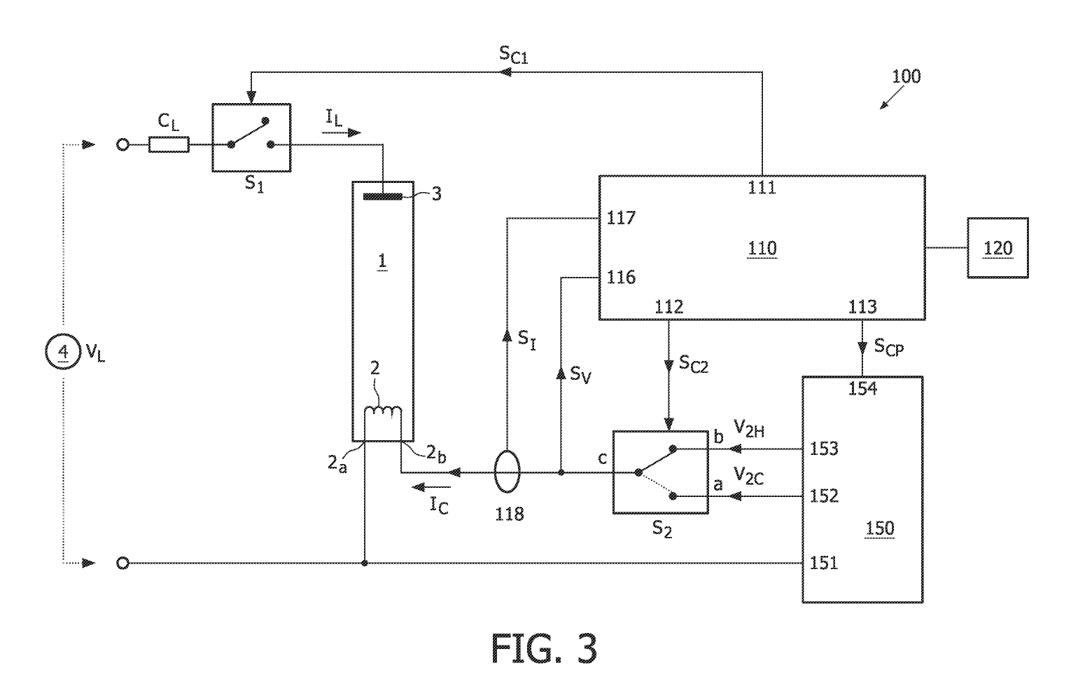

FIG. 3 schematically shows a block diagram of a lamp driver device 100 for driving a fluorescent lamp 1. As compared to the device illustrated in FIG. 1, the important differences are that the electrode power source 150 is a controllable power source, controlled by the controller 110.

More specifically, the controller 110 has a first output 111, providing a first control signal S_{C1} for controlling the first switch S1. The controller 110 further has a second control output 112 providing a second control signal S_{C2} for controlling the second switch S2. The controller 110 has a third control output 113 providing a power control signal S_{CP} for controlling the electrode power source 150.

The electrode power source 150 has a first output terminal 151 connected directly to the lamp electrode 2, and second and third output terminals 152 and 153 connected to input terminals a and b of the second controllable switch S2, respectively. The second controllable switch S2 is of a type having an output terminal c which is either connected to the first input terminal a or to the second input terminal b, depending on the second control signal S_{C2} received from the controller 110. The output terminal c of the second controllable switch S2 is connected to the second electrode terminal 2b. The electrode power source 150 further has a control input 154 receiving the power control signal S_{CP} from the controller 110.

In the embodiment illustrated, the controllable electrode power source 150 continuously provides two different output voltages V_{2C} and V_{2H} at its second and third output terminals 152 and 153, respectively, where the second output voltage V_{2H} at the third output terminal 153 is higher than the first output voltage V_{2C} at the second output terminal 152. Depending on the operative state of the second switch S2, the lamp voltage provided at the output c of the second switch S2 is then either equal to the first output voltage V_{2C} or equal to the second output voltage V_{2H}. As an alternative, it is possible that the controllable electrode power source 150 is of a type having only one output terminal directly connected to the lamp electrode 2b, and that the power source 150 is controllable to provide a low output voltage V_{2C} or a high output voltage V_{2H} at this one output terminal. In that case, a separate second switch S2 is no longer necessary, and the controller 110 does no longer have to provide the second control signal S_{C2} for this second switch.

The controller 110 has a first sense input 116, receiving a voltage sense input signal S_{V} representing the voltage at the output terminal c of the second switch S2, which therefore indicates the voltage drop over the lamp electrode 2. The controller 110 has a second sense input 117, receiving a current sense input signal S_{I} provided by a current sensor 118 associated with the connection from switch output terminal c to lamp electrode 2. This current sensor 118 may be any suitable type, as will be clear to a person skilled in the art, so that it is not necessary here to further explain the details of the current sensor 118.

It is noted that the electrode power source 150 may be a voltage source, so that the resulting electrode current I_{C} is determined by the resistance of the lamp electrode 2, but it is also possible that the electrode power source 150 is a current source, so that the electrode current I_{C} is determined by the power source 150 while the electrode voltage is determined by the electrode resistance. The phrase “power source” is used to cover both possibilities.

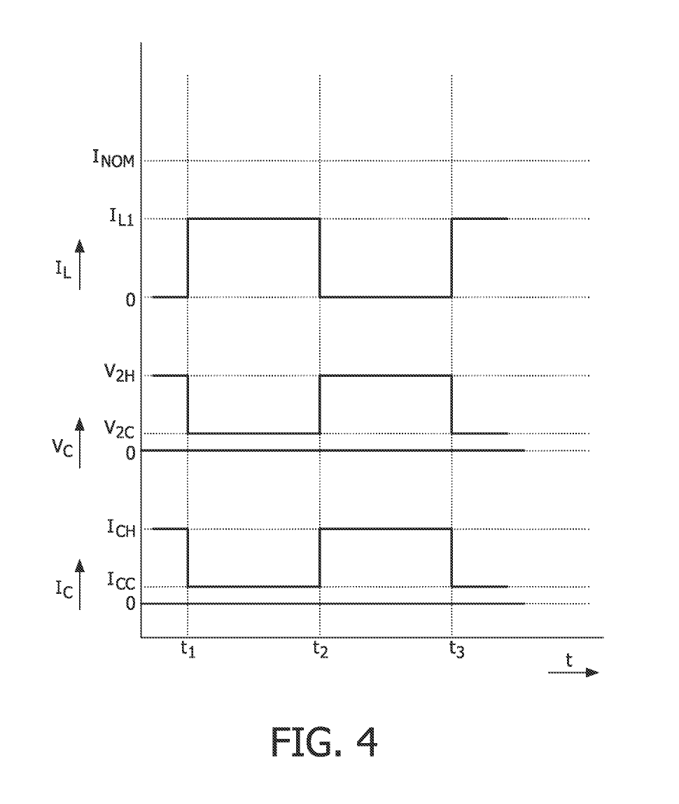

With also reference to FIG. 4, which is a timing diagram showing the behavior of some signals as a function of time, the operation of the driver device 100 is as follows.

On time t1, the controller 110 controls the first controllable switch S1 to close, so that the lamp current I_{L} flows with a current magnitude I_{L1} lower than the nominal current value I_{NOM}. FIG. 4 illustrates this current as a constant current, but actually the current has a high-frequency component in the order of about 20-200 kHz; the current magnitude I_{L1} is the average value of this high-frequency current.

Simultaneously, the controller 110 controls the second switch S2 to switch to the operative condition where output terminal c is connected to the first input terminal a, indicated as first operative condition AC, resulting in the lamp electrode 2 receiving a low electrode voltage V_{2C}, as illustrated in FIG. 4. Also, the electrode current I_{C} will have a low current magnitude I_{CC}, as also shown in FIG. 4. The electrode heating power can now be written as P_{CC}=V_{2C}·I_{CC}.

At time t2, the controller 110 controls the first switch S1 to open, so that the lamp current is interrupted, and simultaneously the controller 110 generates the second control signal S_{C2} for the second switch S2 to switch over to the second operative condition where the output terminal c is connected to the second input terminal b, indicated as second operative condition BC. As a result, the electrode voltage V_{C} is switched to the high voltage value V_{2H}, and the electrode current I_{C} is increased to the high current magnitude I_{CH}. The electrode heating power can now be written as P_{CH}=V_{2H}·I_{CH}.

On time t₃, the first switch S1 is closed again, and the second switch S2 is switched to its first operative state AC again.

The time interval from t1 to t2 will be indicated as ON period, the time interval from t2 to t3 will be indicated as OFF period. It is noted that the applied electrode heating current is substantially constant during the ON period, and is also substantially constant during the OFF period. It is further noted that the applied electrode heating current and the applied lamp current are always switched substantially simultaneously.

During the ON period, the heat input into the lamp electrode 2 is determined by the current magnitude I_{L1} of the lamp current I_{L} and the current magnitude I_{CC} of the electrode current I_{C}. During the OFF period, the heat input into the lamp electrode 2 is determined by the current magnitude I_{CH} of the electrode current I_{C} (more specifically: the corresponding power I_{CH}×V_{2H}). As a result of these three heat input contributions, the lamp electrode 2 takes a certain electrode temperature T, which is substantially constant over the current period t₁-t₃. The driver device is designed to operate such that the electrode temperature T is within a certain operational range. The controller 110 may be designed to monitor this electrode temperature on the basis of measuring the electrode resistance.

It is known that the electrode resistance is influenced by the electrode temperature, so that the electrode resistance is a reliable indication of the electrode temperature. It has been found that the electrode temperature has a suitable operational value if the electrode resistance is about 4.7±0.4 times as high as the electrode resistance of the cold electrode (i.e. room temperature). Expressed in a formula:

4.3≦R_{H}/R_{C}≦5.1 (1)

wherein R_{C} indicates the cold electrode resistance and
wherein R_{H} indicates the hot electrode resistance. The above range from 4.3 to 5.1 will be indicated as the operational range of the electrode resistance, while the value of 4.7 will be indicated as the optimal operational value of the electrode resistance.

As explained above, the controller 110 has three possible heat sources for the electrode to control, and the optimal operational value of the electrode resistance can be achieved with several settings of these three heat sources. However, the inventors have found that the specific settings of said three heat sources play an important role, and the present invention provides a set of rules for the settings of these three heat sources, as will be explained in the following.

### 1. The Lamp Current Magnitude

It is possible to achieve the optimal operational value of the electrode resistance R_{H}=4.7·R_{C} with a continuous lamp current, without electrode heating. The lamp current magnitude required for such operation is indicated as nominal current I_{NOM}. According to a first aspect of the present invention, the setting of the lamp current magnitude I_{L1} during the ON period of the lamp is selected substantially lower than the nominal current I_{NOM}. More particularly, the lamp current magnitude I_{L1} is preferably set according to the following formula:

I_{L1}≦0.9×I_{NOM} (2)

### 2. The Electrode Current Magnitude

The remaining heat input required for achieving the desired temperature setting is provided by the (power of the) electrode heating current I_{CC} during the ON period and I_{CH} during the OFF period. In principle, the controller 110 has some freedom in selecting a combination of these current magnitudes. Preferably, these current magnitudes are selected such that the following formulas are satisfied:

I_{CC}≧0.1×I_{NOM} (3A)

I_{CH}≈I_{CC}+I_{L1} (3B)

Formula 3B means that the overall current through the electrode is substantially constant in time. In an alternative approach, it would also be possible, in stead of formula 3B, to apply the following formula:

I_{CH}=I_{CC} (3C)

indicating that the electrode heating current through the electrode is substantially constant in time.

### 3. The Duty Cycle

The duty cycle may be varied within relative wide limits. It should be clear that, when the setting of the lamp current magnitude I_{L1} remains constant, the settings for the current magnitudes I_{CH} and I_{CC} may depend on the duty cycle. According to an important aspect of the invention, the duty cycle is set at a value more than 0% and less than 100%. Preferably, the duty cycle Δ is set in accordance with the following formula:

5%≦Δ≦70% (4A)

Preferably, the operational range of the electrode resistance is adapted to the duty cycle Δ, such that the operational range decreases with decreasing duty cycle. When a width σ of the operational range is defined such that the operational range extends from 4.7−σ to 4.7+σ, the width σ of the operational range is preferably set according to the following formula:

σ=0.166+0.33·Δ for 0.05≦Δ≦0.7 (4B)

According to the present invention, it has been found that operating the lamp in accordance with the above formulas results in very good performance and reduction of the above-mentioned problems. The temperature distribution of the electrode is very homogenous, and the cathode drop is relatively low. Specifically, a very long lifetime is achieved for all duty cycles, which is a surprising result because in general the duty cycle dimming operation is considered as reducing the lifetime. The invention makes it possible to make lamps with smaller electrodes while maintaining or even improving the lifetime. Further, the invention makes it possible to manufacture one general lamp design, which can be operated as a high light output lamp or a low light output lamp, as desired, simply by changing the setting of the duty cycle and corresponding current settings.

It is noted that the “cold” resistance R_{C} of the lamp electrode 2 is a fixed property of the lamp. In a typical application, the lamp and the controller/power supply are manufactured as a fixed combination, and in such cases the known value of the “cold” resistance R_{C} can be stored in a memory associated with the controller, indicated at 120. Or, this value may be incorporated in the software of the controller. In cases where the controller/power supply and the lamp are manufactured separately, and are combined later, for instance by a user, the controller may have a measuring mode for measuring the “cold” resistance R_{C}: without lamp current, a small measuring electrode current I_{M} is applied to the lamp electrode, and the resulting electrode voltage V_{M} is measured, so that the “cold” resistance R_{C} of the lamp electrode 2 can be calculated according to the following formula:

R_{C}=V_{M}/I_{M} (5)

In cases where the “cold” resistance R_{C} varies in time, during the lifetime of the lamp, this will also be a characteristic of the lamp that is known in advance and can be stored in a controller memory.

During lamp operation, the controller 110 may be designed to calculate the hot electrode resistance R_{H} during the OFF-periods according to the following formula:

R_{H}=V_{2H}/I_{CH} (6)

However, also the hot electrode resistance R_{H} can be considered as a device property that is known in advance. More specifically, it is possible to determine in advance the characteristic of resistance R_{H} as a function of power input, and this characteristic can be stored in a memory. Then, during operation, the controller 110 does not need to actually measure the hot electrode resistance R_{H} but may suffice with selecting a power setting for the electrode heating current selected in accordance with the predetermined characteristic. In such cases, the detectors for measuring electrode voltage (S_{V}) and electrode current (S_{I}) and the corresponding input terminals 116 and 117 can be omitted.

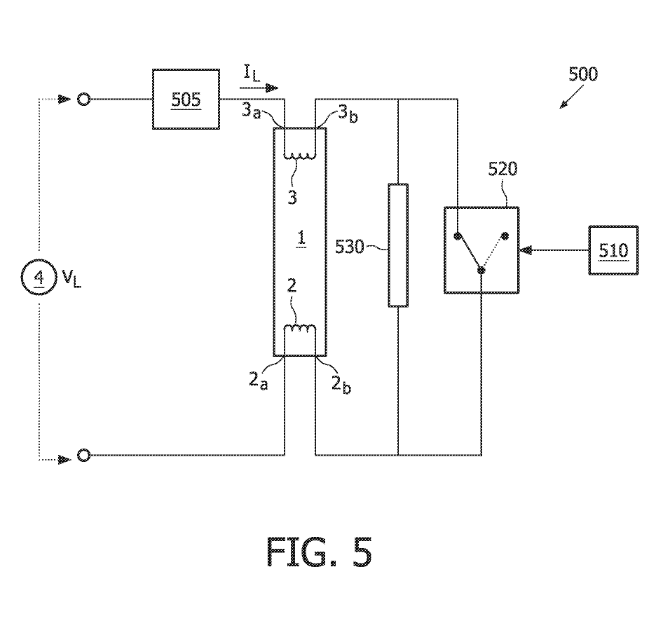

In the embodiment of FIG. 3, the driver device has two functionally separate power supplies, one for the lamp current and one for the electrode heating current, and a controller controlling the current magnitudes. FIG. 5 schematically illustrates a simplified driver device 500, having only one common power supply 4. The lamp 1 has two electrode filaments 2, 3, each having electrode terminals 2a, 2b and 3a, 3b, respectively. The power supply 4 is connected to electrode terminals 2a and 3a, with an electronic ballast 505 in series. The other electrode terminals 2b and 3b are coupled to a controllable switch 520, controlled by a controller 510, with an electronic load 530 connected in parallel to the switch 520. The electronic ballast 505 takes care of providing the required lamp current, especially the combination of DC current level and HF current component.

### On Period

When the switch 520 is OPEN, the output voltage of the power source 4 and/or ballast 505 is available over the lamp 1. In the lamp 1, a lamp current I_{L} will flow. In the parallel load 530, an electrode heating current I_{CC} will flow. The ballast 505 provides a supply current I_{S}=I_{L}+I_{CC}.

### Off Period

When the switch 520 is CLOSED, the lamp is short-circuited, and the supply current I_{S} will flow through the electrodes 2, 3 and the switch 520 as electrode heating current I_{CH}. In this design, the supply current I_{S} as provided by the electronic ballast 505 and the impedance of the load 530 are set to meet the above formulas. The controller 510 controls the duty cycle; variations in the duty cycle require no adaptations of the supply current I_{S}.

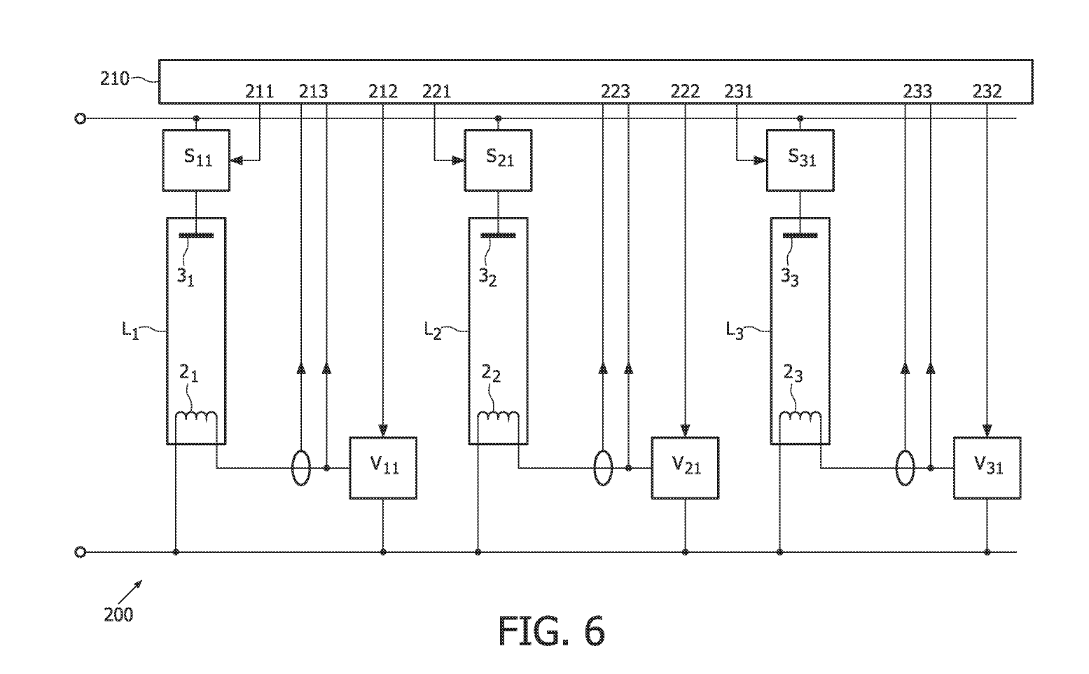

FIG. 6 schematically illustrates a driver device 200, suitable for driving a plurality of lamps according to the principles of the present invention, based on the design of FIG. 3; an alternative design based on the design of FIG. 5 is also possible. In the illustration of FIG. 6, only three lamps L1, L2, L3 are shown, but the invention is of course also applicable for an array of two lamps, or an array of four or more lamps. The lamps are all connected to the first power source V1, each lamp L1, L2, L3 having a corresponding first controllable switch S₁₁, S₂₁, S₃₁ connected in series between the lamp anode 31, 32, 33 and the positive power rail 4b. The driver device 200 has a controller 210, which has control outputs 211, 221, 231 coupled to the first controllable switches S₁₁, S₂₁, S₃₁, respectively.

Each lamp L1, L2, L3 has its cathode 21, 22, 23 connected to a controllable power source V₁₁, V₂₁, V₃₁, respectively. Each of the electrode power sources can be considered to be equivalent to the combination of electrode power source 150 and second controllable switch S2 discussed in the above with reference to FIG. 3. The controller 210 has control output terminals 212, 222, 232 coupled to control input of these electrode power sources V₁₁, V₂₁, V₃₁, respectively.

Further, the controller 210 has sense input terminals 213, 223, 233, receiving information on the electrode voltage and electrode current, respectively, of the lamps L1, L2, L3, respectively.

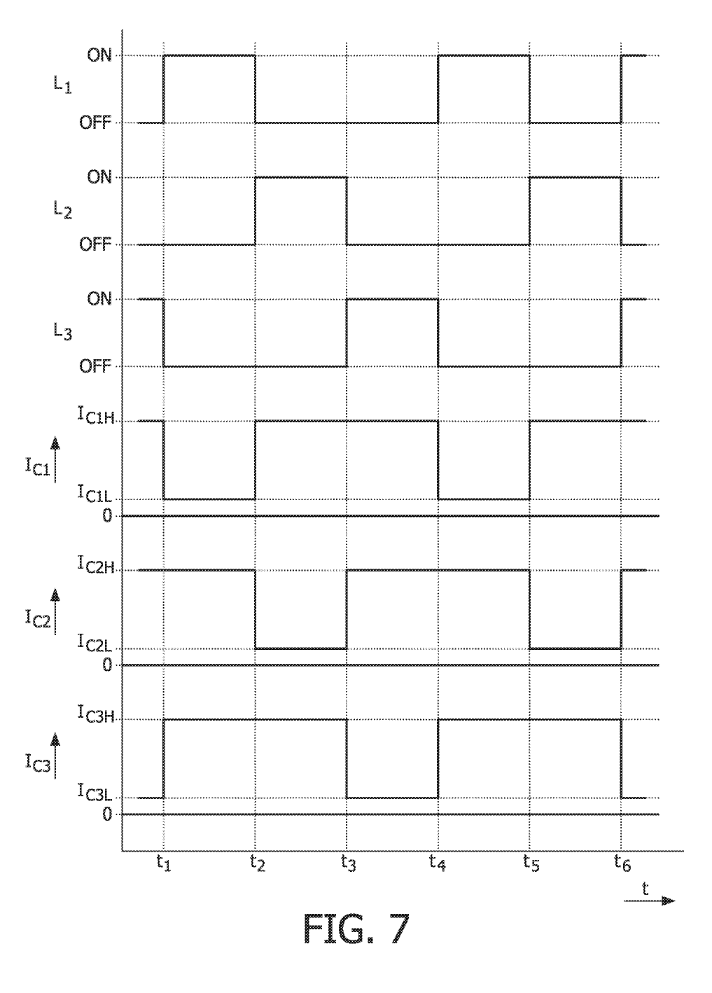

The operation of the driver device 200 is illustrated in FIG. 7. On time t₁, the controller 210 closes the first controllable switch S₁₁ of the first lamp L1, while the controllable switches S₂₁ and S₃₁ of the second and third lamps are open. Thus, only the first lamp L1 has a lamp current flowing. Also on time t₁, the controller 210 instructs the first electrode power source V₁₁ to provide a low electrode heating current I_{C1L}, so that the controller 210 is capable of measuring the hot electrode resistance R_{H1} of the first electrode 21 on the basis of the electrode voltage and electrode current information received at its sense input 213, as explained in the above.

On time t₂, the controller 210 opens the first controllable switch S₁₁ and closes the second controllable switch S₂₁, so that the first lamp L1 goes to its OFF-state while the second lamp L2 goes to its ON-state. Simultaneously, the controller 210 controls the second electrode power source V₂₁ to provide low electrode heating current I_{C2L}, allowing the controller 210 to calculate the hot electrode resistance R_{H2} of the second lamp electrode 22. Regarding the first lamp L1, the controller 210 controls the first electrode power source V₁₁ to provide high electrode heating current.

On time t₃, the controller 210 opens the controllable switch S₂₁ of the second lamp L2, so that this second lamp L2 is switched to its OFF-state, and closes the controllable switch S₃₁ of the third lamp L3, so that this third lamp L3 is switched to its ON-state. Simultaneously, the controller 210 controls the third electrode power source V₃₁ to provide low electrode heating current I_{C3L}, allowing the controller 210 to calculate the hot electrode resistance R_{H3} of the third lamp electrode 23 on the basis of the voltage and current information received at its sense input 233, and controls the second electrode power source V₂₁ to provide high electrode heating current I_{C2H}.

On time t₄, the first lamp L1 is switched ON again and the third lamp is switched OFF. Simultaneously, the controller 210 controls the third electrode power source V₃₁ to provide high electrode heating current I_{C3H}, and controls the first electrode power source V₁₁ to provide low electrode heating current I_{C1L}.

It should be clear to a person skilled in the art that the present invention is not limited to the exemplary embodiments discussed above, but that several variations and modifications are possible within the protective scope of the invention as defined in the appending claims.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for driving a discharge lamp (1) having lamp electrodes (2, 3), at least one of said electrodes (2) being implemented as a filament having two electrode terminals (2a, 2b) and a cold resistance R_{C} at room temperature, the method comprising the following steps:
during a first time interval (t1-t2), causing a discharge lamp current (I_{L}) to flow in said discharge lamp (1) between said two lamp electrodes (2, 3), wherein said one electrode (2) is acting as cathode;
during a second time interval (t2-t3), interrupting the discharge lamp current (I_{L});
during both time intervals (t1-t3), applying an electrode heating voltage (V_{C}) to said two electrode terminals (2a, 2b) of said one electrode (2) such as to pass an electrode heating current (I_{C}) through said one electrode (2);
wherein, during said first time interval (t1-t2), the electrical power supplied to the lamp is such that the discharge lamp current (I_{L}) has a magnitude (I_{L1}) less than the nominal current magnitude (I_{NOM}), wherein the nominal current magnitude (I_{NOM}) is the value which, when the lamp would be operated in a continuous discharge mode without additional electrode heating current being applied, would result in the said one electrode (2) having an operational temperature such that its hot resistance R_{H} is between 4.3 and 5.1 times the cold resistance R_{C}; and
wherein the magnitude of the electrode heating current (I_{C}) is set such that the hot resistance R_{H} of said one electrode (2) is within said range of 4.3 to 5.1 times the cold resistance R_{C}.

2. Method according to claim 1, wherein, during said first time interval (t1-t2), the discharge lamp current (I_{L1}) is less than 0.9 times the nominal current magnitude (I_{NOM}).

3. Method according to claim 1, wherein the magnitude of the electrode heating current (I_{C}) is set such that the hot resistance R_{H} of said one electrode (2) is approximately 4.7 times the cold resistance R_{C}.

4. Method according to claim 1, wherein the magnitude of the electrode heating current (I_{C}) is set in relation to the duty cycle A of the lamp current such that the hot resistance R_{H} of said one electrode (2) is approximately a times the cold resistance R_{C},
α being in the range from 4.7−σ to 4.7+σ,
wherein α=0.166+0.33·Δ for 0.05≦Δ≦0.7

5. Method according to claim 1, wherein, during said first time interval (t1-t2), the electrode heating current (I_{C}) has a magnitude (I_{CC}) at least equal to or larger than 0.1 times the nominal current magnitude (I_{NOM}).

6. Method according to claim 1, wherein, during said second time interval (t2-t3), the electrode heating current (I_{C}) has a magnitude (I_{CH}) substantially higher than the electrode heating current magnitude (I_{CC}) during said first time interval (t1-t2).

7. Method according to claim 6, wherein, during said second time interval (t2-t3), the electrode heating current (I_{C}) has a magnitude (I_{CH}) substantially equal to the summation of the discharge lamp current (I_{L1}) and the electrode heating current magnitude (I_{CC}) during said first time interval (t1-t2).

8. Method according to claim 1, wherein, during said second time interval (t2-t3), the electrode heating current (I_{C}) has a magnitude (I_{CH}) substantially equal to the electrode heating current magnitude (I_{CC}) during said first time interval (t1-t2).

9. Method according to claim 1, wherein the duty cycle (Δ=(t1-t2)/(t1-t3)) is at least equal to or larger than 5%.

10. Method according to claim 1, wherein the duty cycle (Δ=(t1-t2)/(t1-t3)) is at most equal to or smaller than 70%.

11. Method according to claim 1,
wherein, during said second time interval (t2-t3), the “hot” voltage (V_{2H}) over said two electrode terminals (2a, 2b) is measured and the “hot” current (I_{CH}) through said two electrode terminals (2a, 2b) is measured; and
wherein the “hot” electrode resistance R_{H} is calculated as the ratio between the “hot” voltage (V_{2H}) and the “hot” current (I_{CH}).

12. Lamp driver device (100; 200; 500) for driving at least one discharge lamp (1; L1, L2, L3) having at least one electrode (2; 2₁, 2₂, 2₃) implemented as a filament having two electrode terminals (2a, 2b), the driver device being designed to perform the method of claim 1.

13. Lamp driver device (200) according to claim 12, for driving a plurality of discharge lamps (L1, L2, L3) such that always at least one of said lamps is ON while the others are OFF.

14. Scanning backlight system, comprising a lamp driver device according to claim 13.
